(19) United States
(12) Patent Application Publication
(10) Pub. No.: US 2016/0104563 A1
(43) Pub. Date: Apr. 14, 2016

(54) CHIP ELECTRONIC COMPONENT

(71) Applicant: SAMSUNG ELECTRO-MECHANICS CO., LTD., Suwon-Si (KR)

(72) Inventors: Dong Jin JEONG, Suwon-Si (KR); Sin Gon KIM, Suwon-Si (KR)

(21) Appl. No.: 14/668,816

(22) Filed: Mar. 25, 2015

(30) Foreign Application Priority Data
Oct. 14, 2014 (KR) 10-2014-0138452

(51) Int. Cl. H01F 27/28; H01F 27/24

(52) U.S. Cl. CPC H01F 27/2804; H01F 27/24; H01F 2027/2809

(57) ABSTRACT

There is provided a chip electronic component including: a magnetic body including an insulating substrate and having a size thereof in a length direction thereof larger than that in a width direction thereof; and an internal coil part provided on at least one surface of the insulating substrate, wherein a width of the internal coil part measured in the length direction of the magnetic body on the basis of the center of the magnetic body in the width direction thereof is larger than a width of the internal coil part measured in the width direction of the magnetic body on the basis of the center of the magnetic body in the length direction thereof.

### CROSS-REFERENCE TO RELATED APPLICATION

This application claims the priority and benefit of Korean Patent Application No. 10-2014-0138452 filed on Oct. 14, 2014, with the Korean Intellectual Property Office, the disclosure of which is incorporated herein by reference.

### BACKGROUND

The present disclosure relates to a chip electronic component.

An inductor, a chip electronic component, is a representative passive element, configuring an electronic circuit together with a resistor and a capacitor to remove noise therefrom. Such an inductor may be combined with a capacitor using electromagnetic properties to configure a resonance circuit amplifying a signal in a specific frequency band, a filter circuit, or the like.

As information technology (IT) devices such as communications devices, display devices, or the like, have been designed to be relatively compact and thin, research into technology for miniaturizing and thinning various elements such as inductors, capacitors, transistors, and the like, used in such IT devices has been continuously undertaken. Therefore, inductors have been rapidly replaced by small-sized, highly dense chips capable of being automatically surface-mounted, and thin film type inductors in which a mixture of magnetic powder and resin is formed as a coil pattern on upper and lower surfaces of a thin film insulating substrate by plating have been developed.

Inductance (L) and direct current (DC) resistance (Rdc) are the main characteristics of inductors, and DC resistance (Rdc) may be reduced as a cross-sectional area of a coil is increased. In addition, an inductance (L) value of the inductor may be changed, depending on an area of an internal magnetic part through which a magnetic flux passes.

Therefore, research into an inductor having low DC resistance (Rdc) and high inductance (L) is required.

### RELATED ART DOCUMENT

(Patent Document 1) Japanese Patent Laid-Open Publication No. 2006-278479

### SUMMARY

An aspect of the present disclosure may provide a chip electronic component having improved inductance (L).

According to an aspect of the present disclosure, a chip electronic component may include: a magnetic body including an insulating substrate and having a size thereof in a length direction thereof larger than that in a width direction thereof; and an internal coil part provided on at least one surface of the insulating substrate, wherein a width of the internal coil part measured in the length direction of the magnetic body on the basis of the center of the magnetic body in the width direction thereof is larger than a width of the internal coil part measured in the width direction of the magnetic body on the basis of the center of the magnetic body in the length direction thereof.

When the width of the internal coil part measured in the width direction of the magnetic body on the basis of the center of the magnetic body in the length direction thereof is a and the width of the internal coil part measured in the length direction of the magnetic body on the basis of the center of the magnetic body in the width direction thereof is b, 0.8<a/b<1 may be satisfied.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view of a chip electronic component according to an exemplary embodiment in the present disclosure, together with an internal coil part included therein;

FIG. 2 is a plan view of the chip electronic component of FIG. 1;

FIG. 3 is a cross-sectional view taken along line A-A′ of FIG. 2; and

FIG. 4 is a cross-sectional view taken along line B-B′ of FIG. 2.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

### Chip Electronic Component

Hereinafter, a chip electronic component according to an exemplary embodiment in the present disclosure will be described, and in particular, a chip inductor will be described by way of example. However, the present inventive concept is not limited thereto.

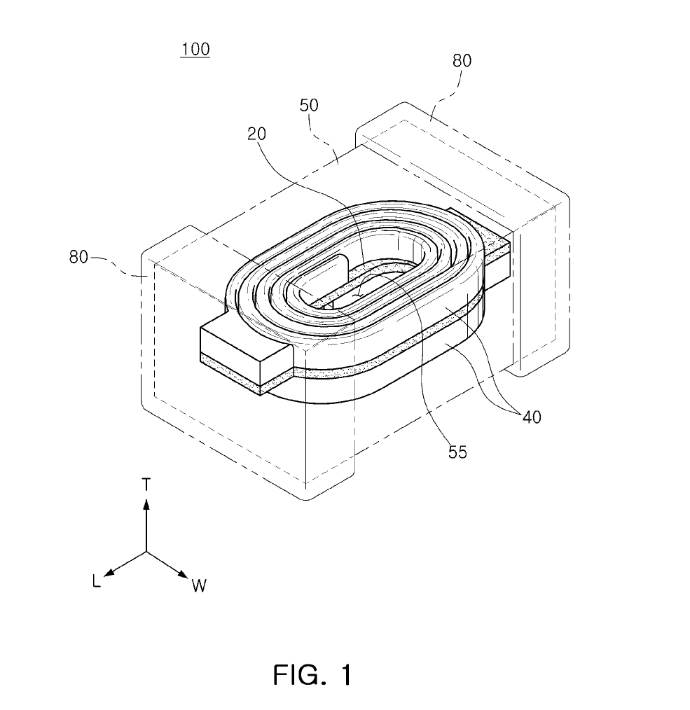

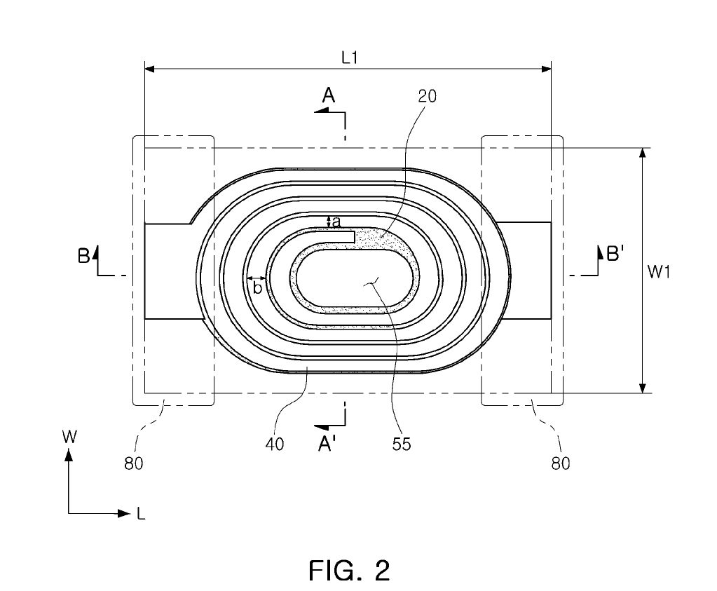

FIG. 1 is a schematic perspective view of a chip electronic component according to an exemplary embodiment in the present disclosure with an internal coil part included therein; and FIG. 2 is a plan view of the chip electronic component of FIG. 1.

Referring to FIGS. 1 and 2, a chip inductor 100 used in a power line of a power supply circuit is illustrated as an example of a chip electronic component according to an exemplary embodiment. The chip electronic component may be a chip bead, a chip filter, or the like, as well as the chip inductor.

The chip inductor 100 may include a magnetic body 50, an insulating substrate 20, an internal coil part 40, and external electrodes 80.

The magnetic body 50 may form the exterior appearance of the chip inductor 100 and may be formed of any material that exhibits magnetic properties. For example, the magnetic body 50 may be filled with ferrite or a metal based soft magnetic material.

The ferrite may include ferrite known in the art, such as Mn—Zn based ferrite, Ni—Zn based ferrite, Ni—Zn—Cu based ferrite, Mn—Mg based ferrite, Ba based ferrite, or Li based ferrite.

The metal based soft magnetic material may be an alloy containing at least one selected from the group consisting of Fe, Si, Cr, Al, and Ni. For example, the metal based soft magnetic material may contain Fe—Si—B—Cr based amorphous metal particles, but is not limited thereto.

The metal based soft magnetic material may have a particle diameter of 0.1 to 20 μm and may be dispersed in a polymer such as an epoxy resin or polyimide.

The magnetic body 50 may have an approximately hexahedral shape. Directions of a hexahedron will be defined in order to clearly describe an exemplary embodiment in the present disclosure. L, W and T shown in FIG. 1 refer to a length direction, a width direction, and a thickness direction, respectively. The magnetic body 50 may have a hexahedral shape.

As shown in FIG. 2, in a case that a length of the magnetic body is L1 and a width of the magnetic body is W1, L1>W1 may be satisfied.

The insulating substrate 20 provided in the magnetic body 50 may be, for example, a polypropylene glycol (PPG) substrate, a ferrite substrate, or a metal based soft magnetic substrate.

The insulating substrate 20 may have a through hole in a central portion thereof, and the through hole may be filled with a magnetic material such as ferrite or a metal based soft magnetic material to form a core part 55. The core part 55 may be formed to be filled with the magnetic material, thereby improving inductance (L).

The insulating substrate 20 may have the internal coil part 40 having a coil pattern formed on one surface thereof. In addition, the internal coil part 40 have a coil pattern may also be formed on the other surface of the insulating substrate 20.

The internal coil part 40 may include the coil patterns having a spiral shape, and the coil patterns of the internal coil part 40 formed on one surface and the other surface of the insulating substrate 20 may be electrically connected to each other through a via electrode 45 formed in the insulating substrate 20.

As shown in FIG. 2, a width of the internal coil part 40 measured in the length direction of the magnetic body on the basis of the center of the magnetic body in the width direction thereof may be larger than a width of the internal coil part 40 measured in the width direction of the magnetic body on the basis of the center of the magnetic body in the length direction thereof.

For example, as shown in FIG. 2, a width of the internal coil part 40 in a region adjacent to an end surface of the magnetic body in the length direction thereof maybe larger than a width of the internal coil part in a region adjacent to aside surface of the magnetic body in the width direction thereof.

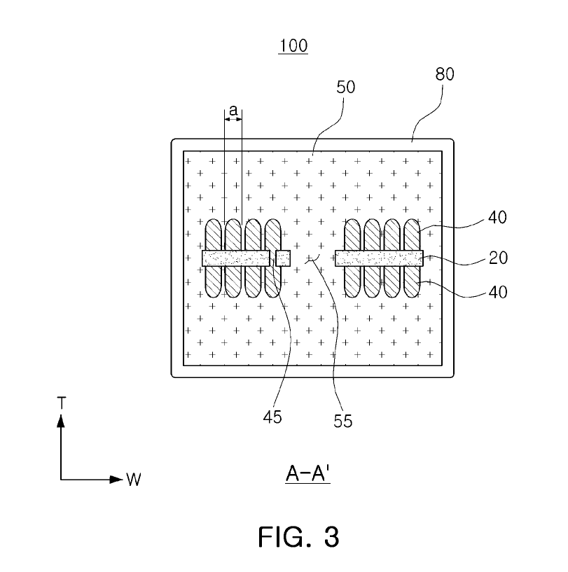

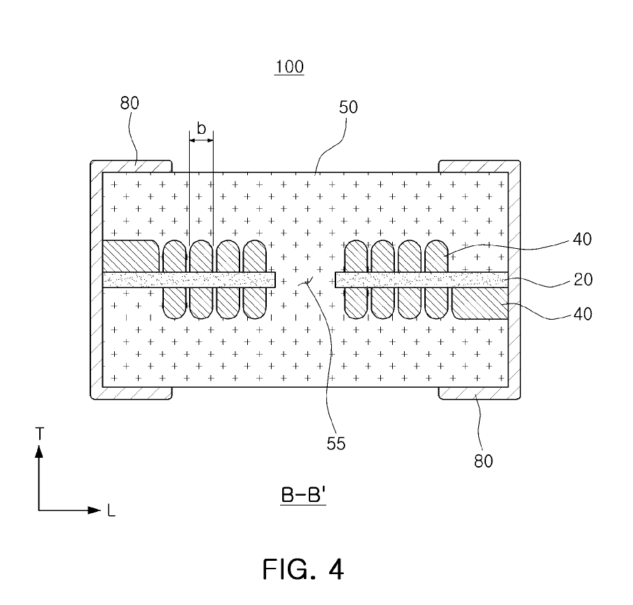

FIG. 3 is a cross-sectional view taken along line A-A′ of FIG. 2; and FIG. 4 is a cross-sectional view taken along line B-B′ of FIG. 2.

As shown in FIGS. 3 and 4, according to an exemplary embodiment in the present disclosure, in a case that the width of the internal coil part 40 measured in the width direction of the magnetic body 50 on the basis of the center of the magnetic body 50 in the length direction thereof is a and the width of the internal coil part 40 measured in the length direction of the magnetic body 50 on the basis of the center of the magnetic body 50 in the width direction thereof is b, a<b may be satisfied.

Here, the width of the internal coil part 40 refers to a width of a lower surface of the internal coil part in contact with the insulating substrate 20.

Generally, sizes of chip electronic components may differ in length and width directions in order to secure directions of chips in chip measurement, chip selection and chip processing. In detail, the size of a chip electronic component in the length direction thereof may be larger than that of the chip electronic component in the width direction thereof.

According to an exemplary embodiment in the present disclosure, in the chip inductor in which a size L1 of the magnetic body 50 in the length direction thereof is larger than a size W1 thereof in the width direction, the width of the internal coil part 40 is non-uniform, whereby an area of the core part 55 may be increased. Therefore, inductance of the chip inductor may be increased.

For example, an area of the core part 55 may be larger than that of a core part which includes an internal coil part having a uniform width, and inductance of the chip inductor may be improved.

According to an exemplary embodiment, the internal coil part 40 may be formed to have a relatively small width in the width direction of the magnetic body 50 and have a relatively large width in the length direction of the magnetic body 50, whereby the area of the core part 55 may be optimized.

As described above, in a case in which the area of the core part 55 is increased by adjusting the width of the internal coil part 40, an increase rate indirect current (DC) resistance (Rdc) may be lower than an increase rate in inductance, whereby the inductance may be increased without significantly increasing a DC resistance value.

In addition, according to an exemplary embodiment, in the case that the width of the internal coil part 40 measured in the width direction of the magnetic body 50 on the basis of the center of the magnetic body 50 in the length direction thereof is a and the width of the internal coil part 40 measured in the length direction of the magnetic body 50 on the basis of the center of the magnetic body 50 in the width direction thereof is b, 0.8<a/b<1 may be satisfied.

In a case in which a/b<1 is satisfied, area efficiency and inductance of the core part 55 may be improved.

In addition, in a case in which 0.8<a/b is satisfied, a ratio of the increase rate in DC resistance (Rdc) to the increase rate in inductance may be less than 50%, whereby the inductance of the inductor may be increased and deterioration thereof resulting from an increase in DC resistance (Rdc) may be suppressed.

The internal coil part 40 maybe formed of a metal having excellent electrical conductivity, for example, silver (Ag), palladium (Pd), aluminum (Al), nickel (Ni), titanium (Ti), gold (Au), copper (Cu), platinum (Pt), or an alloy thereof.

The internal coil part 40 may be coated with an insulating layer (not shown).

The insulating layer may be formed by a method well-known in the art such as a screen printing method, an exposure and development method of a photoresist (PR), a spraying method. The internal coil part 40 may be coated with the insulating layer, such that it may not directly contact a magnetic material forming the magnetic body 50.

One end portion of the internal coil part 40 formed on one surface of the insulating substrate 20 may be exposed to one end surface of the magnetic body 50 in the length direction thereof, and one end portion of the internal coil part 40 formed on the other surface of the insulating substrate 20 may be exposed to the other end surface of the magnetic body 50 in the length direction thereof.

The external electrodes 80 may be formed on both end surfaces of the magnetic body 50 in the length direction thereof, respectively, so as to be connected to the end portions of the internal coil part 40 exposed to both end surfaces of the magnetic body 50 in the length direction thereof, respectively. The external electrodes 80 may be extended to both surfaces of the magnetic body 50 in the thickness direction thereof and/or both side surfaces of the magnetic body 50 in the width direction thereof.

The external electrodes 80 may be formed of a metal having excellent electrical conductivity, for example, nickel (Ni), copper (Cu), tin (Sn), silver (Ag), or an alloy thereof.

The following table 1 shows an increase rate in a core area, an increase rate in inductance (L), an increase rate in DC resistance (Rdc), and a ratio of the increase rate in DC resistance (Rdc) to the increase rate in inductance (L), depending on a ratio (a/b) of the width a of the internal coil part measured in the width direction to the width b of the internal coil part measured in the length direction in the case that the width of the internal coil part measured in the width direction of the magnetic body on the basis of the center of the magnetic body in the length direction thereof is a and the width of the internal coil part measured in the length direction of the magnetic body on the basis of the center of the magnetic body in the width direction thereof is b.

In samples 1 to 5 of Table 1, respective magnetic bodies had the same size.

In table 1, sample 1 was a reference sample in measuring the increase rate in the core area, the increase rate in inductance (L), the increase rate in DC resistance (Rdc), and the ratio of the increase rate in DC resistance (Rdc) to the increase rate in inductance.

Samples 2 to 5 were tested by gradually decreasing the width a of the internal coil part measured in the width direction of the magnetic body on the basis of the center of the magnetic body in the length direction thereof in a state in which the width b of the internal coil part measured in the length direction of the magnetic body on the basis of the center of the magnetic body in the width direction thereof was fixed as compared with the values of sample 1.

With regard to an area of the core part obtained by decreasing the width a of the internal coil part measured in the width direction of the magnetic body on the basis of the center of the magnetic body in the length direction thereof, the internal coil part was disposed in a direction in which the area of the core part is widened.

TABLE 1

| | | | | | Ratio of |
|---|---|---|---|---|---|
| | | | | Increase | Increase Rate in |
| | | Increase | Increase | Rate | DC Resistance to |
| | | Rate in Area | Rate in | in DC | Increase Rate in |
| Sample | a/b | of Core Part | Inductance | Resistance | Inductance |
| 1 | 1 | 0% | 0% | 0% | — |
| 2 | 0.83 | 14% | 14% | 6% | 43% |
| 3 | 0.67 | 26% | 26% | 18% | 69% |
| 4 | 0.50 | 39% | 39% | 30% | 77% |
| 5 | 0.33 | 51% | 51% | 44% | 86% |

It can be seen from table 1 that in a case in which a/b was less than 1, inductance was increased due to an increased area of the core part.

In addition, in a case in which a/b exceeded 0.8 and was less than 1, the ratio of the increase rate in DC resistance to the increase rate in inductance was less than 50%, thereby efficiently improving the inductance without significantly increasing the DC resistance.

### Method of Manufacturing Chip Electronic Component

Next, a method of manufacturing a chip electronic component according to an exemplary embodiment in the present disclosure will be described.

First, the internal coil part 40 may be formed on at least one surface of the insulating substrate 20.

The insulating substrate 20 is not particularly limited, but may be, for example, a polypropylene glycol (PPG) substrate, a ferrite substrate, or a metal based soft magnetic substrate, and may have a thickness of, for example, 40 to 100 μm.

A method of forming the internal coil part 40 may be, for example, an electroplating method, but is not limited thereto. The internal coil part 40 may be formed of a metal having excellent electrical conductivity, for example, silver (Ag), palladium (Pd), aluminum (Al), nickel (Ni), titanium (Ti), gold (Au), copper (Cu), platinum (Pt), or an alloy thereof.

The width a of the internal coil part 40 measured in the width direction of the magnetic body on the basis of the center of the magnetic body in the length direction thereof may be less than the width b of the internal coil part 40 measured in the length direction of the magnetic body on the basis of the center of the magnetic body in the width direction thereof.

The internal coil part may be formed to have non-uniform widths by differently adjusting a width of a plating resist at the time of performing pattern plating or adjusting the concentration of a plating solution and current density at the time of performing electroplating.

The internal coil part may be formed to have different widths in the length direction and the width direction of the magnetic body, whereby the inductance (L) may be improved.

According to this exemplary embodiment, in the case that the width of the internal coil part measured in the width direction of the magnetic body on the basis of the center of the magnetic body in the length direction thereof is a and the width of the internal coil part measured in the length direction of the magnetic body on the basis of the center of the magnetic body in the width direction thereof is b, the internal coil part may be formed to satisfy 0.8<a/b<1.

A hole may be formed in a portion of the insulating substrate 20 and may be filled with a conductive material to form the via electrode 45, and coil patterns of the internal coil part 40 formed on one surface and the other surface of the insulating substrate 20, respectively, may be electrically connected to each other through the via electrode 45.

Drilling, laser processing, sand blasting, punching, or the like, may be performed on a central portion of the insulating substrate 20 to form a through hole penetrating through the insulating substrate.

After the internal coil part 40 is formed, an insulating layer (not shown) may be formed to coat the internal coil part 40. The insulating layer may be formed by a method well-known in the art such as a screen printing method, an exposure and development method of a photoresist (PR), a spraying method, or the like, but is not limited thereto.

Next, magnetic layers may be disposed on and below the insulating substrate 20 having the internal coil part 40 formed thereon, to form the magnetic body 50.

The magnetic layers may be stacked on both surfaces of the insulating substrate 20, respectively, and be compressed by a lamination method or an isostatic pressing method to form the magnetic body 50. Here, the through hole may be filled with the magnetic material to form the core part 55.

Next, the external electrodes 80 may be formed to be connected to the internal coil part 40 exposed to at least one end surface of the magnetic body 50.

The external electrode 80 may be formed of a paste containing a metal having excellent electrical conductivity, for example, a conductive paste containing nickel (Ni), copper (Cu), tin (Sn), or silver (Ag), or an alloy thereof. The external electrodes 80 may be formed by a dipping method, or the like, as well as a printing method depending on a shape thereof.

A description of features that are the same as those of the chip electronic component according to the previous exemplary embodiment will be omitted.

As set forth above, in a chip electronic component according to exemplary embodiments, the area efficiency of a core part may be improved.

In addition, according to exemplary embodiments, the chip electronic component may have low DC resistance (Rdc) and improved inductance (L).

While exemplary embodiments have been shown and described above, it will be apparent to those skilled in the art that modifications and variations could be made without departing from the scope of the invention as defined by the appended claims.

What is claimed is:

1. A chip electronic component comprising:
a magnetic body including an insulating substrate and having a size thereof in a length direction thereof larger than that in a width direction thereof; and
an internal coil part provided on at least one surface of the insulating substrate,
wherein a width of the internal coil part measured in the length direction of the magnetic body on the basis of the center of the magnetic body in the width direction thereof is larger than a width of the internal coil part measured in the width direction of the magnetic body on the basis of the center of the magnetic body in the length direction thereof.

2. The chip electronic component of claim 1, wherein when the width of the internal coil part measured in the width direction of the magnetic body on the basis of the center of the magnetic body in the length direction thereof is a and the width of the internal coil part measured in the length direction of the magnetic body on the basis of the center of the magnetic body in the width direction thereof is b, 0.8<a/b<1 is satisfied.

3. The chip electronic component of claim 1, wherein the internal coil part has a spiral shape.

4. The chip electronic component of claim 1, wherein the insulating substrate has a through hole in a central portion thereof, the through hole being filled with a magnetic material to form a core part.

5. The chip electronic component of claim 4, wherein an area of the core part is larger than that of a core part which includes an internal coil part having a uniform width.

6. The chip electronic component of claim 1, wherein the internal coil part is exposed to an end surface of the magnetic body in the length direction thereof.

7. The chip electronic component of claim 1, wherein the internal coil part includes coil patterns which are provided on one surface of the insulating substrate and the other surface of the insulating substrate opposing one surface of the insulating substrate and are electrically connected to each other by a via electrode provided in the insulating substrate.

8. The chip electronic component of claim 1, wherein the internal coil part contains at least one selected from the group consisting of silver (Ag), palladium (Pd), aluminum (Al), nickel (Ni), titanium (Ti), gold (Au), copper (Cu), and platinum (Pt).

9. A chip electronic component comprising:
a magnetic body including an insulating substrate and having a size thereof in a length direction thereof larger than that in a width direction thereof;
an internal coil part provided on at least one surface of the insulating substrate and having a spiral shape; and
external electrodes provided on at least one end surface of the magnetic body in the length direction thereof and connected to the internal coil part,
wherein a width of the internal coil part in a region of the magnetic body adjacent to the end surface of the magnetic body in the length direction thereof is larger than that of the internal coil part in a region of the magnetic body adjacent to a side surface of the magnetic body in the width direction thereof.

10. The chip electronic component of claim 9, wherein when a width of the internal coil part measured in the width direction of the magnetic body on the basis of the center of the magnetic body in the length direction thereof is a and a width of the internal coil part measured in the length direction of the magnetic body on the basis of the center of the magnetic body in the width direction thereof is b, 0.8<a/b<1 is satisfied.

11. The chip electronic component of claim 9, wherein the insulating substrate has a through hole in a central portion thereof, the through hole being filled with a magnetic material to form a core part.

12. The chip electronic component of claim 11, wherein an area of the core part is larger than that of a core part which includes an internal coil part having a uniform width.

13. The chip electronic component of claim 9, wherein the internal coil part includes coil patterns which are provided on one surface of the insulating substrate and the other surface of the insulating substrate opposing one surface of the insulating substrate and are electrically connected to each other by a via electrode provided in the insulating substrate.
